(19) United States
(12) Patent Application Publication
(10) Pub. No.: US 2018/0126686 A1
(43) Pub. Date: May 10, 2018

(54) Automated Packaging Material Crumpler

(71) Applicant: Encore Packaging LLC, Lake Bluff, IL (US)

(72) Inventors: Timothy H. Nelson, Winnetka, IL (US); Yinghao Shi, Chicago, IL (US); John Parks, Mundelein, IL (US)

(21) Appl. No.: 15/804,468

(22) Filed: Nov. 6, 2017

Related U.S. Application Data
(60) Provisional application No. 62/418,211, filed on Nov. 6, 2016.

(51) Int. Cl. B31D 5/00

(52) U.S. Cl. CPC B31D 5/0052; B31D 2205/0058; B26D 5/10; B31D 2205/0082; B31D 2205/0023

(57) ABSTRACT

A crumpling apparatus including a frame, a funnel coupled to the frame, the funnel having a first opening and a second opening, the first opening being larger than the second opening, at least one mount located proximate to the first opening, the mount being configured to support a roll of packing material, and a drive device coupled to the frame proximate to the second opening of the funnel. The drive device pulls packing material through the funnel. The funnel further includes at least one sidewall defining a cross section, the cross section being larger near the first opening and smaller near the second opening. The at least one sidewall crumples the packing material as is moves from the first opening to the second opening.

### RELATED APPLICATIONS

This application claims priority to U.S. provisional application No. 62/418,211, filed on Nov. 6, 2016, which is hereby incorporated by reference in its entirety.

### FIELD

This invention relates generally to the packaging industry and, more specifically, to crumpling paper or other materials to use as a packing material.

### BACKGROUND

When packing or shipping objects that do not fit tightly into a box, it is generally known in the industry to provide some sort of cushioning material to fill the voids in the box so as to protect the contained object. Traditionally foam packing peanuts, bubble wrap, and other similar materials were used to fill these voids. Crumpled materials, specifically crumpled paper, is also generally known in the industry as to cushion objects during shipping. Unlike typical foam peanuts and plastic bubble wrap, crumpled paper is biodegradable. The crumpled paper is placed in the box or package around the object, and thus when the object shifts, the crumpled paper prevents the object from crashing into the sides of the box and potentially being damaged.

### SUMMARY

Generally speaking and pursuant to these various embodiments, a crumpling apparatus includes one or more mounts for rolls of paper. The paper unrolls into a funnel device that crumples it. The crumpled paper in turn is fed through a pair of adjacent wheels that further the crumpling effect. A motor drives one of both of the wheels to pull the crumpled paper through the apparatus. A cutter cuts the crumpled paper into shorter sections for use in packing.

So configured, one or more rolls of paper can be quickly crumpled and cut into short sections for use as a packing material. Alternatively, other materials can be crumpled by the same apparatus for use as packing materials or as cushioning for other operations.

### BRIEF DESCRIPTION OF THE FIGURES

Embodiments of the invention are illustrated in the figures of the accompanying drawings in which:

FIG. 1 comprises a front perspective view of an example crumpling apparatus for crumpling paper in accordance with various embodiments of the invention;

FIG. 2 comprises an isolated view of the drive device of the crumpling apparatus of FIG. 1;

FIG. 3 comprises a bottom view of the drive device of FIG. 2;

FIG. 4 comprises a perspective view of the inner components of the drive device of FIGS. 2-3;

FIG. 5 comprises an expanded view of the channel and wheels of the drive device of FIGS. 2-4;

FIG. 6 comprises a perspective view of the funnel structure of the crumpling apparatus of FIG. 1;

FIG. 7 comprises an exploded view of an example crumpling apparatus for crumpling paper in accordance with various embodiments of the invention;

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

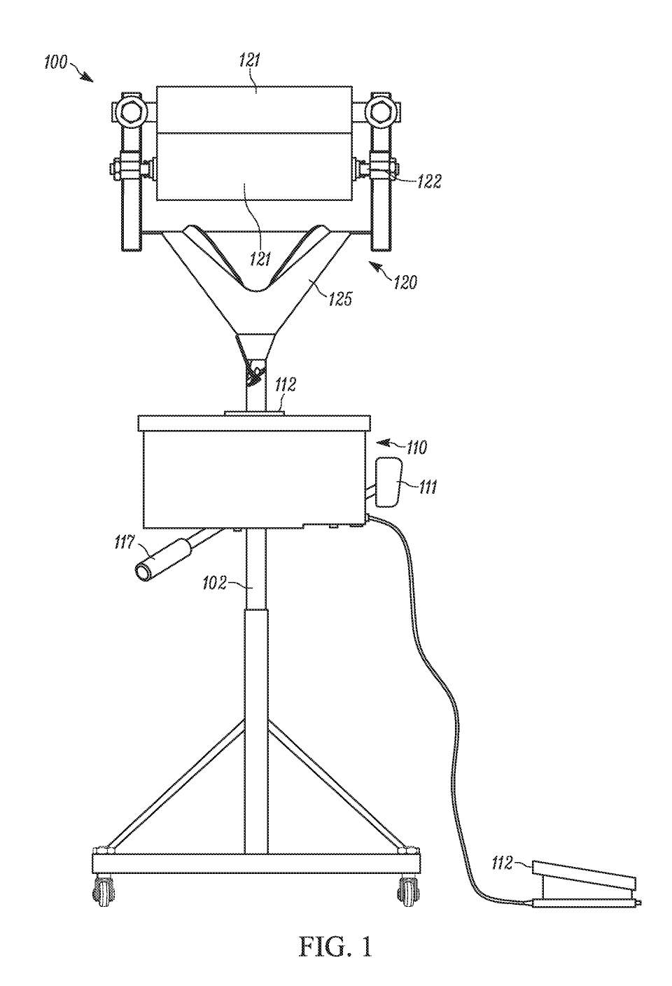

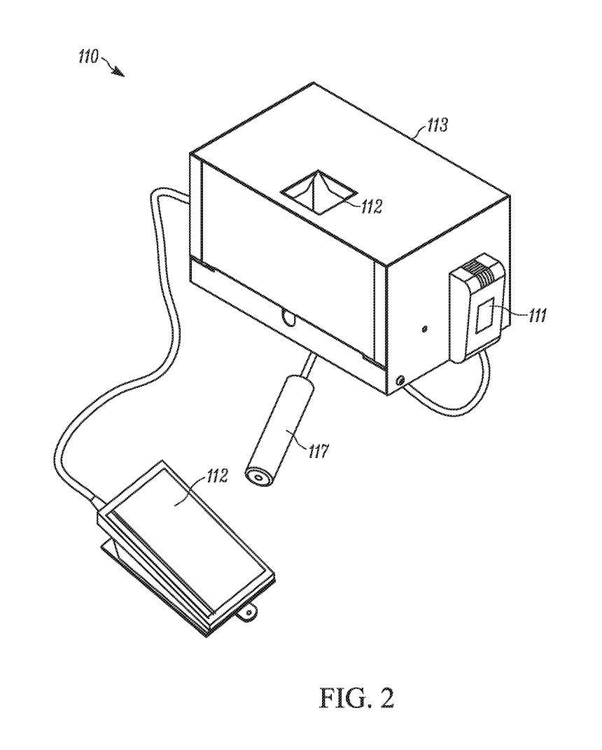

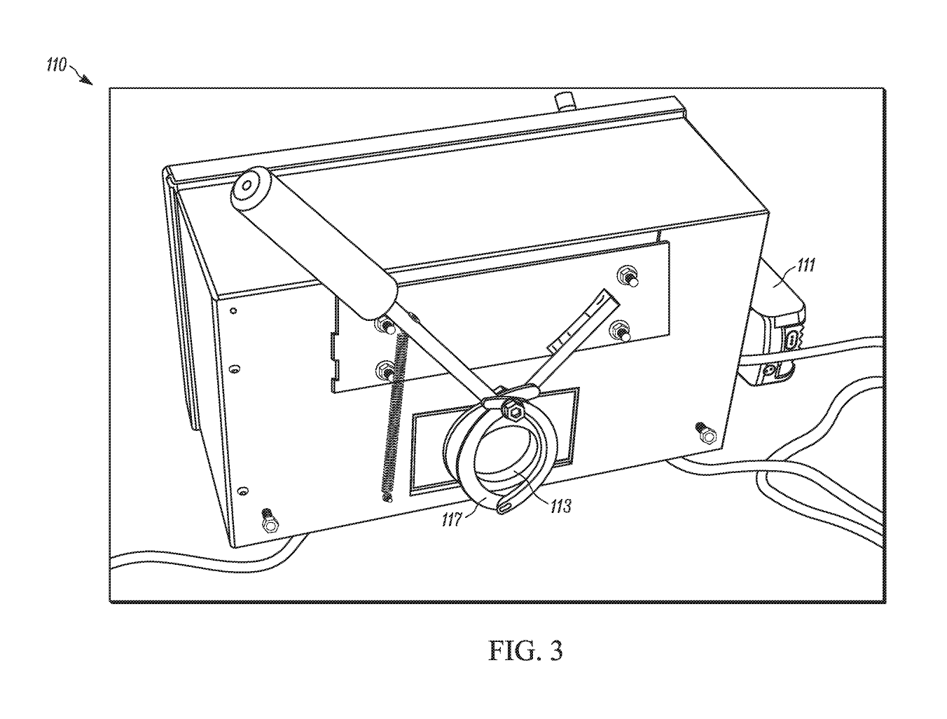

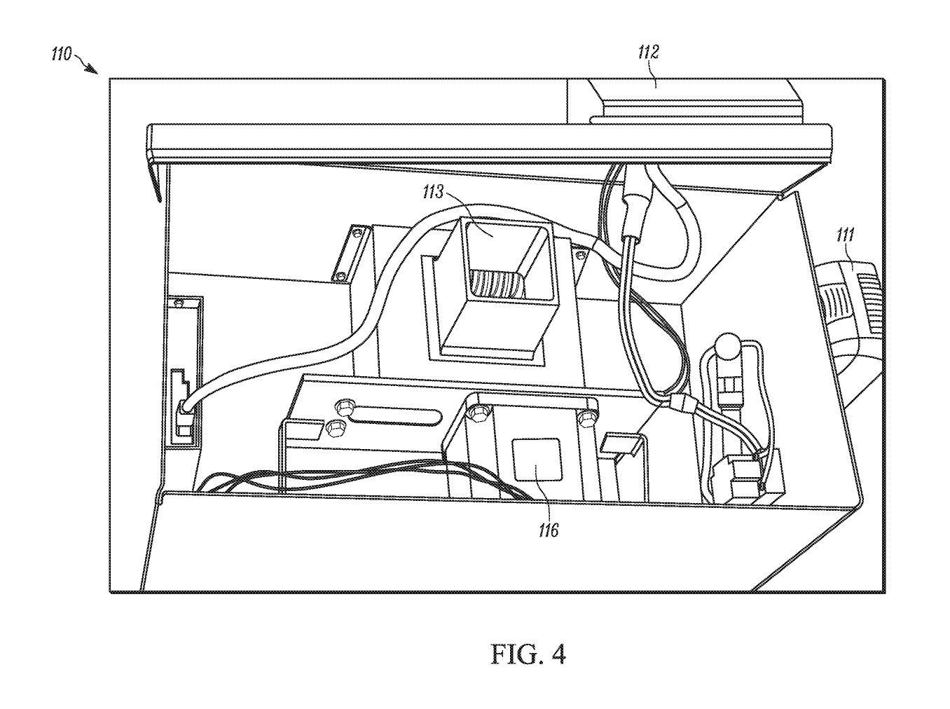

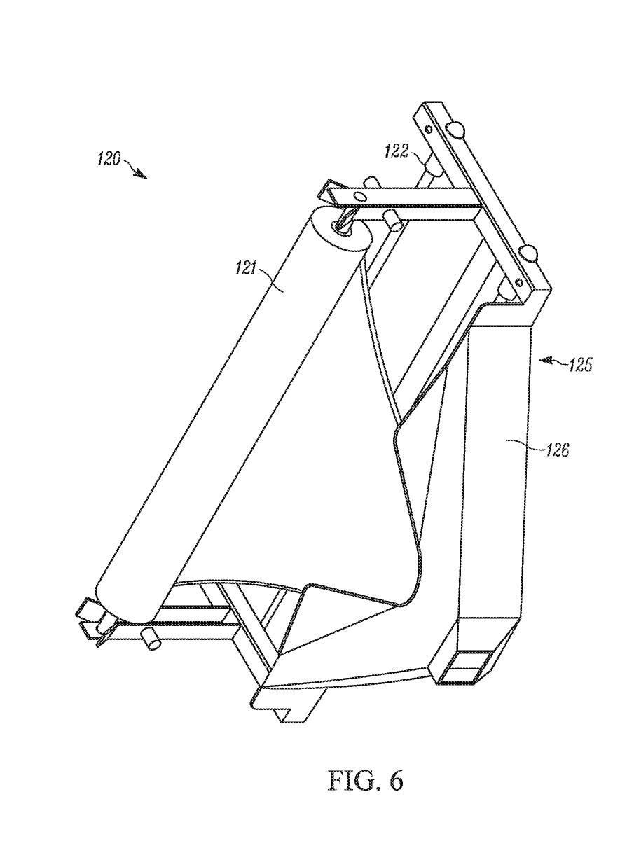

Referring now to the drawings, and in particular FIGS. 1-6, an example of an apparatus for crumpling packing material for application as a filler or cushion will be described. The packing material may be any sheet material that is stored on rolls 111, such as paper, plastic, foam, or others. In a preferred embodiment, the packing material is a heavy duty paper, such as kraft paper or indented kraft paper. In this example, the crumpling apparatus 100 comprises a frame 102. The frame 102 supports a drive device 110 and a funnel structure 120. The drive device 110 is positioned in line with the exit of the funnel structure 120 output. The crumpled paper is drawn into the drive device 110 and passes between two adjacent wheels 115. The paper contacts the wheels over a portion of their circumference, and specifically the portion of the circumference where the wheels 115 are closest together. As the motor 116 drives one or both of the wheels 115, the wheels pull the paper downward, which pulls more paper off of the rolls 121 and through the funnel 122 to be crumpled. The wheels 115 push the paper out of the exit of the drive device 110, which passes it through the cutter 117. The cutter 117 can be actuated to cut the crumpled paper into shorter sections.

The funnel structure 120 supports one or more rolls 121 of packing material supported by mounts 122. The mounts 122 enable the rolls 121 to rotate so that the paper thereon unrolls when the free end is pulled. The funnel structure 120 further includes a funnel 125. The funnel 125 has a first end proximate the rolls 121 that is as wide as the packing material. The funnel 125 is at least partially enclosed with an opening at the first end proximate to the rolls 121 and a second opening at the second end distal from the rolls 121. The funnel 125 includes at least one sidewall disposed to reduce a cross-sectional area of the funnel 125 from near the first opening to being smaller near the second opening. In the illustrated example, at least two opposite sidewalls 126 slope inward, towards each other, as they move away from the rolls 121 such that the cross-section of the funnel becomes smaller. The inward slanting sidewalls 126 guide the edges of the packing material inward as it is pulled through, causing it to crumple. In alternative embodiments, the funnel 125 is shaped like a truncated cone and thus only has one sidewall 126.

The mounts 122 are detachable from the funnel structure 120 to enable the rolls 121 to be quickly replaced when empty. In some embodiments, the mounts 122 are adjustable relative to the funnel 125 to accommodate different numbers of packing material rolls 121, different types of packing material, and/or different size rolls 121. In still further embodiments, the mounts 122 include a braking mechanism to stop the rolls from continuing to spin once packing material is no longer being pulled through the funnel 125.

The drive device 110 includes a power source 111 and one or more user inputs 112. The user inputs 112 may be a digital input that simply turns the motor 116 on or off, or the user inputs 112 may include analog controls to adjust the speed of the motor 116. In the embodiment shown, the user inputs 112 include a foot pedal connected to provide power to the motor 116 when depressed. The user inputs 112 further include a dial for adjusting the speed of the motor. When the pedal is depressed, the motor is activated and pulls packing material through the funnel structure 120 at a speed corresponding to the location of the dial. The design of the user inputs 112 may vary. For example, the foot pedal may be replaced with a button or switch either on the drive device 110, attached by a cord, or in wireless communication with the drive device 110. The user inputs 112 may include a user interface that allows for both input and output. The user interface may include a screen that displays information to the user, such as the current settings of the crumpling apparatus (such as the speed setting), the amount of packing material held on the rolls 121, and/or the remaining battery life. In some forms, the user interface runs preset programs to crumple and then cut predetermined lengths of packing material. The screen displays the current settings, such as the predetermined length.

The power source 111 may be a plug to connect the crumpling apparatus 100 to a standard outlet, or it may be a battery as shown. In some embodiments, the power source 111 comprises both a power cord and a battery such that the crumpling apparatus 100 can be plugged in to charge the battery, and can run while plugged in while maintaining a full battery charge, or may be unplugged and then run off of the power stored in the battery. The battery may be integral with the drive device 110, such that the drive device 110 needs to be hooked up to the charger in order to recharge the battery. In alternative embodiments, the battery may be detachable, as shown, so as to allow a dead battery to be quickly removed and replaced with a charged battery so that the crumpling apparatus continues operating while the original battery is charged by an external charger.

The drive device 110 further comprises a channel 113 through which the packing material travels. The channel 113 has a first opening proximate to the second opening of the funnel 125. In a preferred form, the first opening of the channel is in line with the second opening of the funnel 125 to avoid pulling the packing material at an angle which may cause it to be worn or torn by the sidewalls 126 at the second opening of the funnel 125.

The channel 113 has a second opening at its distal end, the second opening is located near the cutter 117. When the packing material exits the second opening of the channel 113, it passes through the working area of the cutter 117, so as to be cut when the cutter 117 is actuated.

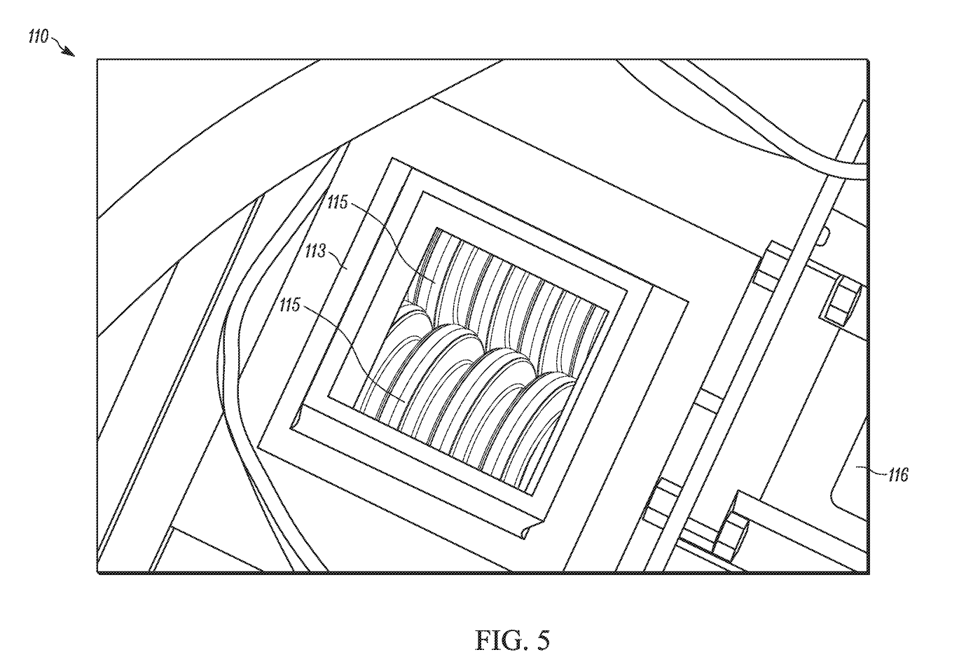

Between the first and second openings, the channel 113 at least partially contains the wheels 115, such that packing material passing through the channel 113 is guided to the space between the wheels 115. The wheels 115 can have a variety of forms including rollers, articulating outer surfaces, ridged outer surfaces, or the like. For instance, as illustrated in FIG. 5, the wheels 115 can have cooperating interlocked ridges between which the packaging materials passes. The wheels 115 are substantially close to each other, such that packing material passing between the wheels 115 is tightly pinched there between. The pinching provides sufficient friction between the packing material and the at least one of the wheels 115 that is driven by the motor 116 to pull the packing material through the crumpling apparatus 100 when the wheel 115 is rotated.

In some embodiments, at least one of the wheels 115 is movable relative to the other wheel 115. The movable wheel 115 is biased towards the other wheel 115 such that the biasing force causes the wheels 115 to pinch packing materials of varying thicknesses (such as a single roll of crumpled paper vs. a double roll of crumpled paper) with substantially the same force.

In addition to driving the packing material, in some embodiments the wheels 115 apply sufficient force to further the crumpling of the packing material. The force affects the memory of the packing material, such that it does not return to its uncrumpled state once removed from the crumpling apparatus 100. This may be done by creasing at least a portion of the folds in the crumpled packing material.

The cutter 117 shown is a manual cutter. When the crumpled packing material outside of the drive device 110 is a sufficient length, the operator pulls the handle of the cutter 117, which causes the blade or blades to cut the packing material. A spring may be included to bias the cutter 117 back towards its starting position such that the operator only needs to actuate the cutter 117 in the first direction. In alternative embodiments, the cutter 117 is automated in which the blades are operably coupled to an electric motor (such as a step motor), a pneumatic or hydraulic piston, or other driving mechanism. A user input causes the motor or piston to actuate the blades, cutting the packing material. In some embodiments, the input to the automated cutter 117 is a button or switch pressed by a user which immediately causes the cutter 117 to actuate. In alternative embodiments, the cutter 117 is automatically actuated after a predetermined amount of packing material has been crumpled. In still further embodiments, the cutter 117 is actuated in response to the motor 116 being activated or deactivated.

In some embodiments, the cutter 117 is removed from the crumpling apparatus 100. Instead of an integrated cutter 117, a separate handheld cutter, such a scissors or a utility knife, is used to cut the crumpled packing material. In further alternatives, the cutter 117 is detached from the drive device 110 and instead coupled to the frame 102. The cutter 117 may be movably coupled to the frame 102, such that it can be adjusted relative to the drive device 110 and/or the funnel structure 120.

In some embodiments, the crumpling apparatus 100 has a manual state and an automated state. The automated state is described above, with the drive device 110 configured to pull packing material through the funnel structure 120. In the manual state, the drive device 110 no longer operates to pull the packing material, instead a user manually pulls on the free end of the packing material to pull the packing material through the funnel structure 120 and crumple it.

In one form, the drive device 110 is detachably coupled to the frame 102. In order to convert from the automated state to the manual state, the drive device 110 is decoupled from the frame 102. If the cutter 117 is movably coupled to the frame 102, it can be moved upward to be closer to the second opening of the funnel 125. In further forms, the drive device 110 is movably coupled to the frame 102. Instead of removing the drive device 110 completely, it is merely moved away from the second opening of the funnel 125 to provide space for the manual pulling of the free end of the packing material. The drive device 110 may be vertically adjustable, such that it may be dropped ways from the funnel structure 120, or may be rotatable about the frame 102 such that it can be moved to another side of the frame 102.

In still further forms, the wheels 115 allow for the packing material to be pulled through the drive device 110 without activating the motor 116. The wheels 115 may be free to rotate independent of the motor 116 such that they do not prevent movement of the packing material, or they may be adjustable away from each other such that they can be moved out of engagement with the packing material for manual operation of the crumpling apparatus.

In operation, one or more rolls 121 of packing material, such as paper, is attached to the mounts 122. The free end of the rolls 121 is fed into the first opening of the funnel 125 and out of the second opening of the funnel 125. The free end is then fed into the first opening of the channel 113 and into engagement with the wheels 115. The free end is pinched between the wheels 115 and held there. A user sends an input via the user inputs 112, such as by pressing down on the foot pedal, which activates the motor 116. The motor 116 rotates at least one of the wheels 115 which drives the packing material through the channel 113. The force imposed on the packing material by the wheels 115 cause the rolls 121 to unroll, feeding more paper material through the funnel 125 and into the drive device 110. The free end of the packing material exits the channel 113 and passes through the working area of the cutter 117. When a sufficient amount of packing material has exited the channel 113 in a crumpled state, the user stops sending an input, which deactivates the motor 116. The user then actuates the cutter 117, which cuts separates the packing crumpled packing material below the drive device 110 from the rest of the roll 121. The cut off portion is used to fill voids in a box to cushion an object during shipping.

In addition to the above-mentioned embodiments, it should be understood that a variety of methods are also disclosed herein. For example, a method of crumpling material, a method of operating a crumpling apparatus, or a method of preparing objects for shipping. These and other methods related to the subject matter set forth herein are intended to be covered by this disclosure. It should also be understood that while certain features have been described with certain embodiments, these features may be intermixed or interchanged with one another to form other embodiments as desired. All features disclosed herein are intended to be used in any of the embodiments disclosed herein either in lieu of similar features or in combination with other features. For example, a crumpling apparatus is considered having an adjustable drive device 110 for converting between manual operation and automated operation in combination with the automated cutter 117 described.

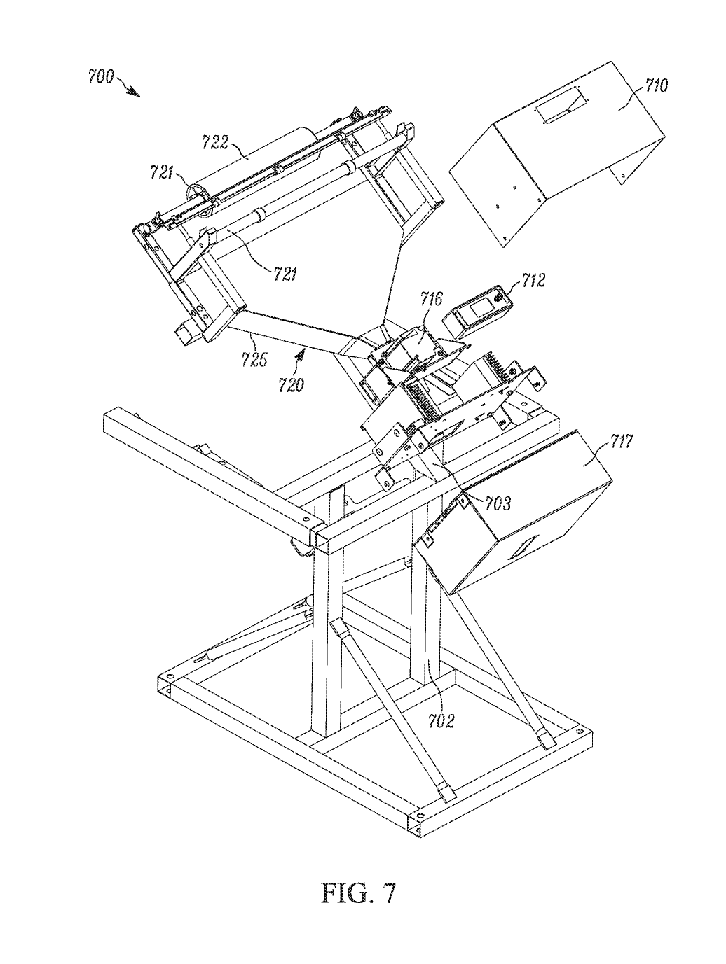

Turning to FIG. 7, a packaging material crumpling device 700 is illustrated in exploded view. Elements of the crumpling device 700 sharing the same last two digits of the element number as elements of the crumpling device 100 are corresponding structures. Corresponding structures are assumed to operate substantially similarly except where expressly distinguished in writing or in the figures. The crumpling device 700 includes a funnel assembly 720, a feeding assembly 710, and a cutting assembly 717 all coupled to a first frame member 703. The first frame member 703 is coupled to a second frame member 702. In some forms, the first frame member 703 is angled, while the second frame member 702 is substantially vertical. Angling the first frame member 703 reduces the height difference between the mounts 721 and the cutter 717, such that packaging material can be both loaded and retrieved at comfortable heights for the user. In some forms, the first frame member 703 is horizontal. In still further embodiments, the first frame member 703 is pivotably attached to the second frame member 702 such that the angle of the first frame member 703 is adjustable.

One or more rolls of packaging material 722 are mounted on the mounts 721. A free end of the packaging material extends through the funnel 725 and into the feeding assembly 710. The packaging material 722, such as paper, is engaged by one or more wheels, such as the wheels 115 above, which are driven by the motor 716. The motor actuates the wheels to pull the material from the roll 722. The funnel 725 as well as compression from the wheels 715 crumple the packaging material such that it is shaped to take up additional volume and be compressible, so as to be used as a cushioning and/or filler material in packages.

The motor 716 is controlled by a controller 712 having a user interface. In some forms, the user interface includes a button or a dial such that the user can directly turn the motor on or off, potentially at adjustable speeds. In alternative forms, the user interface enables the user to input a quantity of or length of crumpled material sections. The controller 712 runs a stored program to control the motor 716 and cutter 715 to produce the input number of sections at the input length.

The cutting assembly 717 includes a cutter within an enclosure. The enclosure reduces the risk of outside objects being inserted in the cutter, intentionally or accidentally, thus increasing the safety of the crumpling device 700. In some forms, the cutting assembly 717 is communicatively coupled to the controller 712, such that the controller 712 controls the cutting assembly 717. For example, the cutting assembly comprises a linear actuator configured to drive one or more blades for cutting the crumpled material. The actuator is actuated by a relay which is communicatively coupled to the controller 712. When a cut output is transmitted from the controller 712, the linear actuator actuates the blades, cutting off a section of the crumpled material.

Alternatively or additionally, the cutting assembly 717 includes a user input, such as a button, configured to operate the actuator. In this form, the user controls the motor 716 with the controller 712 until a desired length of crumpled material is dispensed from the bottom of the cutting assembly 717. The user then turns off the motor 716 and actuates the cutting assembly 717 using the input button.

The motor 716, controller 712, and cutting assembly 717 are powered by a power source, such as the battery 111 described above. Alternatively or additionally, the crumpling device 700 includes a power cable configured to plug into a standard electrical outlet to power the motor 716, controller 712, and cutting assembly 717.

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

Those skilled in the art will recognize that a wide variety of modifications, alterations, and combinations can be made with respect to the above described embodiments without departing from the scope of the invention. For instance, the various aspects of the illustrated crumpling apparatuses can be implemented individually or together in any combination. Such modifications, alterations, and combinations are to be viewed as being within the ambit of the inventive concept.

What is claimed is:

1. A crumpling apparatus comprising:
a frame;
a funnel coupled to the frame, the funnel having a first opening and a second opening, the first opening being larger than the second opening;
at least one mount located proximate to the first opening, the mount being configured to support a roll of packing material; and
a drive device coupled to the frame proximate to the second opening of the funnel, the drive device being configured to pull packing material through the funnel,
wherein the funnel comprises at least one sidewall disposed to reduce a cross-sectional area of the funnel from near the first opening to being smaller near the second opening, and
wherein the at least one sidewall crumples the packing material as is moves from the first opening to the second opening.

2. The crumpling apparatus of claim 1, wherein the packing material is paper.

3. The crumpling apparatus of claim 1, wherein the at least one mount comprises two mounts each configured to support a roll of packing material.

4. The crumpling apparatus of claim 1 further comprising a cutter configured to cut the packing material.

5. The crumpling apparatus of claim 4 wherein the cutter is positioned near an opening of the drive device through which the drive device is configured to drive the crumpled packing material.

6. The crumpling apparatus of claim 4, the cutter comprising a linear actuator and at least one blade.

7. The crumpling apparatus of claim 4, the cutter comprising a handle coupled to at least one blade.

8. The crumpling apparatus of claim 1, the drive device comprising:
at least two wheels; and
a motor mounted and configured to rotate at least one of the at least two wheels,
wherein the packing material contacts at least a portion of the circumference of each of the at least two wheels.

9. The crumpling apparatus of claim 8, wherein at least one of the at least two wheels is biased towards another of the at least two wheels.

10. A method of crumpling packing material comprising:
unrolling packing material from at least one roll;
pulling a free end of the packing material with a drive device through a funnel, the funnel comprising at least one sidewall defining a cross section, the cross section being larger near a first opening and smaller near a second opening;
compressing the packing material with the at least one sidewall of the funnel as it moves from the first opening to the second opening, causing the packing material to crumple; and
cutting the crumpled packing material.

11. The method of claim 10, wherein pulling the free end of the packing material with a drive device comprises:
pinching the packing material between at least two wheels; and
rotating at least one of the at least two wheels.

12. The method of claim 10, wherein unrolling packing material from at least one roll comprises unrolling paper from two rolls.
